(19) United States
(12) Patent Application Publication
(10) Pub. No.: US 2022/0222516 A1
(43) Pub. Date: Jul. 14, 2022

(54) COMPUTATIONALLY EFFICIENT IMPLEMENTATION OF ANALOG NEURON

(71) Applicant: AMS INTERNATIONAL AG, Jona (CH)

(72) Inventors: Bernhard Puchinger, Rapperswil (CH); Ernst HASELSTEINER, Rapperswil (CH); Florian MAIER, Rapperswil (CH); Benjamin MINIXHOFER, Rapperswil (CH); Gilbert PROMITZER, Rapperswil (CH); Philipp JANTSCHER, Rapperswil (CH)

(21) Appl. No.: 17/607,385

(22) PCT Filed: Apr. 29, 2020
(86) PCT No.: PCT/EP2020/061875

§ 371 Date: Oct. 28, 2021

Related U.S. Application Data
(60) Provisional application No. 62/840,365, filed on Apr. 29, 2019.

(51) Int. Cl. G06N 3/063; G06N 3/04

(52) U.S. Cl. CPC G06N 3/0635; G06N 3/04

(57) ABSTRACT

An apparatus includes an analog neural network, a digital controller and a memory device. The analog neural network can include a first layer having a plurality of neurons. The plurality of neurons can be reused to form a second layer of the analog neural network. Each neuron can have a plurality of inputs. The digital controller can be coupled to the analog neural network, and can provide a weight for each input of the plurality of inputs. The memory device can be coupled to the digital controller to store the weight for each input of the plurality of inputs.

### TECHNICAL FIELD

The subject matter described herein relates to a computationally efficient implementation of an analog neuron that can be reused in multiple layers of a neural network.

### BACKGROUND

An artificial neural network (simply referred to as a neural network herein) is a computing system used in machine learning. The neural network can be based on layers of connected nodes referred to as neurons, which can loosely model neurons in a biological brain. Each layer can have multiple neurons. Neurons between different layers are connected via connections, which correspond to synapses in a biological brain. A neuron in a first layer can transmit a signal to another neuron in another layer via a connection between those two neurons. The signal transmitted on a connection can be a real number. The other neuron of the other layer can process the received signal (i.e., the real number), and then transmit the processed signal to additional neurons. The output of each neuron can be computed by some non-linear function based on inputs of that neuron. Each connection can have a weight that can adjust the signal before the signal is processed and the output is computed.

Conventionally, such neural networks typically are implemented digitally. In other words, the neural networks are not typically implemented in analog form, even though analog computations may be more efficient than digital computations, as described below. The neural network has many layers, which necessitates many neurons for each layer. A traditional analog neural network needs a separate electrical component for each neuron within the neural network. When the number of layers increases, the number of electrical components needed to implement the analog neural network also increase, which in turn can require enormous amount of computational requirements, including power, space, processing, and storage requirements. Therefore, analog neural networks are rare, and traditionally ineffective when present.

### SUMMARY

In one aspect, an apparatus is described that includes an analog neural network, a digital controller, and a memory device. The analog neural network can include a first layer having neurons. The neurons can be reused to form a second layer of the analog neural network. Each neuron can have inputs. The digital controller can be coupled to the analog neural network to provide a weight for each input of the inputs. The memory device can be coupled to the digital controller and can store the weight for each of the inputs.

In some implementations, one or more of the following features may be present. For example, the apparatus can include an analog-to-digital converter coupled to the analog neural network to receive an analog output of the analog neural network. The analog-to-digital converter can convert the analog output of the analog neural network to a digital output compatible with the digital controller. The analog-to-digital converter can be coupled to the digital controller to transmit the digital output to the digital controller.

The outputs for each of the neurons can include: an analog input of analog inputs from a sensor coupled to the analog neural network; and an output of each of the neurons. The analog inputs can be input to the first layer of the neural network. A count of the analog inputs can equal a count of the neurons. The analog inputs can be multiplexed to form sets of parallel signals (e.g., six sets of parallel signals, wherein each set includes eight signals). Each set of the sets of parallel signals can be sequentially processed by the analog neural network.

Each neuron can include a first charge pump, a first operational amplifier, a second charge pump, and a second operational amplifier. The first charge pump can be coupled to the first operational amplifier. The second charge pump can be coupled to the second operational amplifier. The first operational amplifier can be operable as a buffer to persist an output of the neuron when associated with the first layer while the second operational amplifier can be operable as an integrator to compute an output of the neuron when being reused as part of the second layer. The second operational amplifier can be operable to switch for operation as another buffer to persist the output of the neuron when being reused as part of the second layer while the first operational amplifier can be operable to switch for operation as another integrator to compute an output of the neuron when being further reused as part of a third layer of the neural network.

Each of the first operational amplifier and the second operational amplifier can be coupled with electrical components configured to perform offset compensation. Each of the first operational amplifier and the second operational amplifier can be coupled with electrical components configured to amplify an output of the analog neural network. Each neuron further can include a clipper circuit configured to clip an output of one of the first operational amplifier and the second operational amplifier to keep the output within a predetermined range of voltage values.

Each neuron of the neurons can have an electrical circuit including switches. Opening and closing of each switch of the switches can be controlled by the digital controller.

In another aspect, an apparatus for an electrical circuit of an analog neuron of a neural network is described. Such apparatus can include: a first operational amplifier configured to act as a buffer to persist an output of the neuron when the neuron is associated with a first layer of the neural network; and a second operational amplifier configured to act as an integrator to compute an output of the neuron when the neuron is being reused as part of a second layer of the neural network.

Some implementations include one or more of the following features. For example, the apparatus can include a first charge pump and a second charge pump. The first charge pump can be coupled to the first operational amplifier. The first charge pump can vary a voltage at an input of the first operational amplifier. The second charge pump can be coupled to the second operational amplifier. The second charge pump can be configured to vary a voltage at an input of the second operational amplifier. The apparatus can further include a clipper circuit that can clip an output of one of the first operational amplifier and the second operational amplifier to keep the output within a predetermined range of voltage values.

The second operational amplifier can be configured to switch to act as another buffer to persist the output of the neuron when being reused as part of the second layer. The first operational amplifier can be configured to switch to act as another integrator to compute an output of the neuron when being further reused as part of a third layer of the neural network. Each of the first operational amplifier and the second operational amplifier can be coupled with electrical components to perform offset compensation. Each of the first operational amplifier and the second operational amplifier can be coupled with electrical components configured to amplify an output of the analog neural network.

Some implementations provide one or more of the following advantages. The reuse of neurons within the neural network can minimize the quantity of electrical components used within the electrical circuit for the neural network, thereby minimizing the amount of computational requirements, including power, space, processing, and storage requirements. Furthermore, the neural network can attain very high parallelism as all neurons can operate at the same time. Further, because the neural network performs calculations as simple analog operations, the neural network can process data quickly. Moreover, because the neural network processes the data efficiency, the neurons may require low power and other computational resources such as processing power, memory, and the like.

The details of one or more implementations are set forth below. Other features and advantages will be apparent from the detailed description, the accompanying drawings, and the claims.

### BRIEF DESCRIPTION OF THE DRAWINGS

FIG. 1 illustrates an example of an electrical chip having an analog neural network.

FIG. 2 illustrates portion of a layer of the neural network.

FIG. 3 illustrates an example of an electrical circuit forming a neuron within the neural network.

FIG. 4 illustrates a digital controller for each neuron.

FIG. 5 illustrates a timing diagram illustrating a functionality of the digital controller.

FIG. 6 illustrates another timing diagram for calculating two layers for one neuron represented by the electrical circuit.

FIG. 7 illustrates a circuit portion—within the electrical circuit of the neuron—that includes a charge pump and an integrator.

FIG. 8 illustrates an electrical circuit that has electrical component additions to the circuit portion of FIG. 7 to perform offset compensation.

FIG. 9 illustrates an electrical circuit that has electrical component additions to the circuit portion of FIG. 8 to perform output amplification.

FIG. 10 illustrates a circuit portion within the electrical circuit of the neuron to perform clipping of the output voltage.

FIG. 11 illustrates another circuit portion to perform clipping of the output voltage.

### DETAILED DESCRIPTION

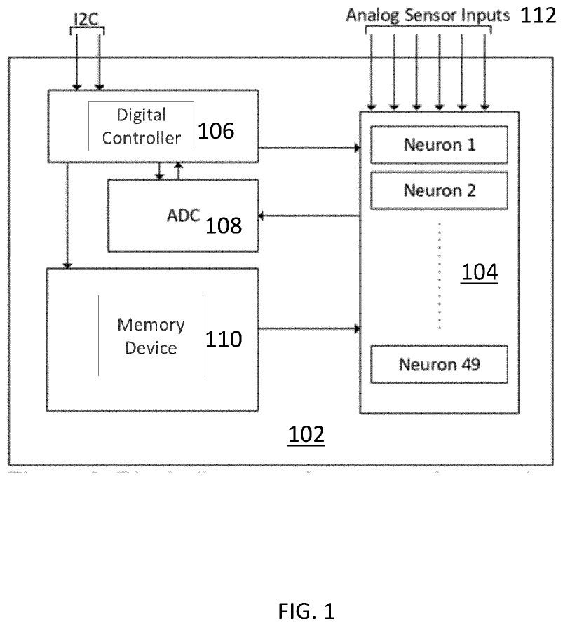

FIG. 1 illustrates an electrical chip 102 having an analog neural network 104 including neurons, a digital controller 106 that can digitally control the electrical circuitry of the analog neural network 104, an analog-to-digital converter (ADC) 108 that can convert an analog output (e.g., output voltage) of each neuron into a digital format compatible with the digital controller 106, and a memory device 110 that can store a corresponding weight for each input of every neuron.

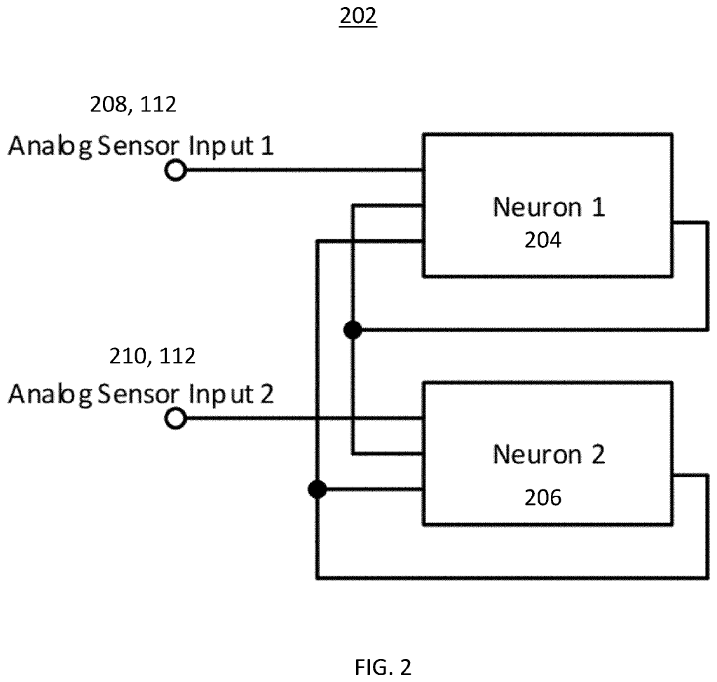

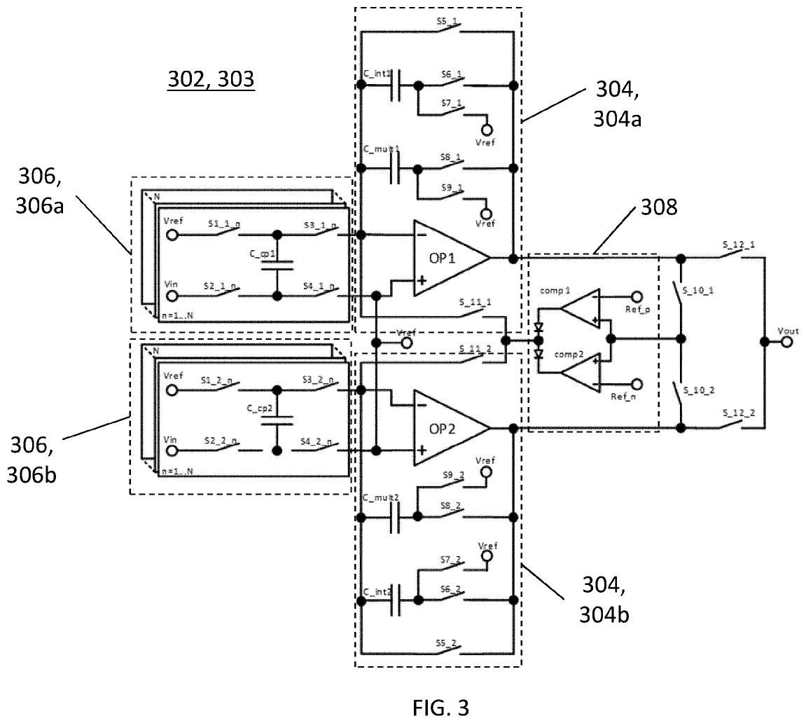

The neural network 104 can include several layers, including an input layer, hidden layers, and an output layer. The input layer of the neural network 104 can have analog sensor inputs 112. The analog neural network 104 can classify data within those inputs 112 into various classes so as to perform machine learning or artificial intelligence. Each neuron in the input layer of the neural network 104 can receive a corresponding single analog sensor input 112, as described below by FIG. 2. Accordingly, the number of analog sensor inputs 112 can be same as the number of neurons in the input layer. In the shown example, the input layer can have 49 neurons, and thus the number of analog sensor inputs 112 can also be 49. The circuitry of each neuron within the neural network 104 is described below by FIGS. 2 and 3.

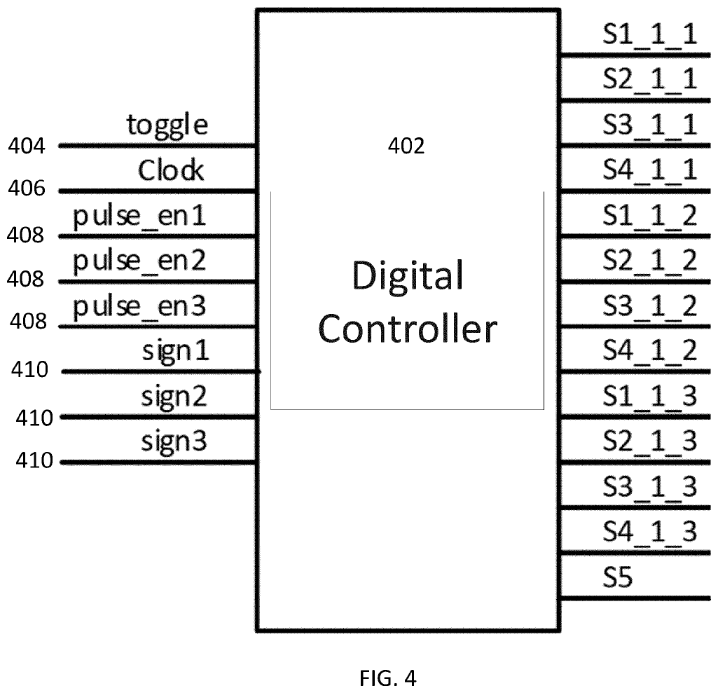

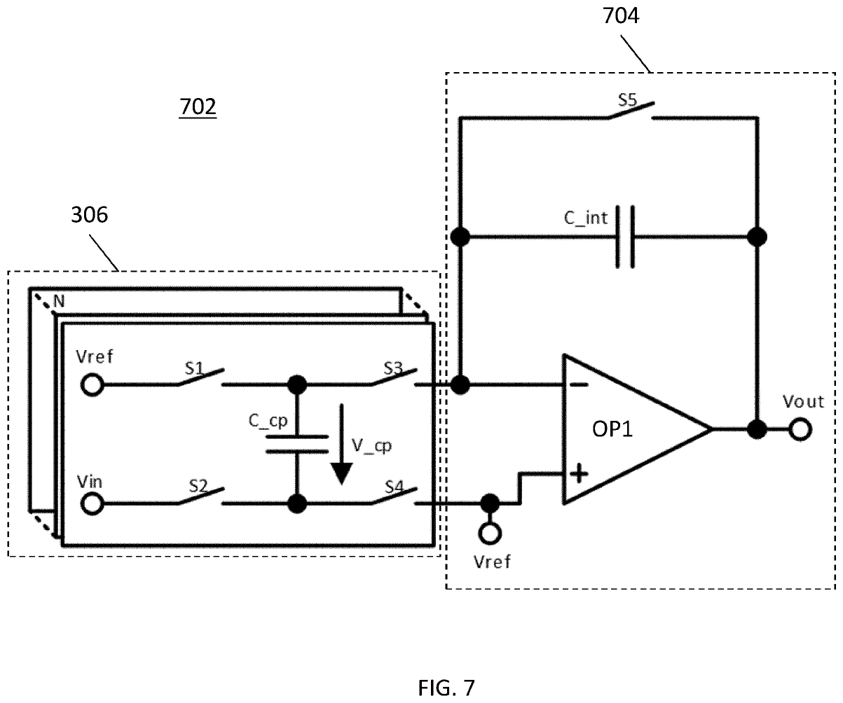

The digital controller 106 can control the circuitry (shown in FIG. 3) of each neuron of the neural network 104. The digital controller 106 can control this circuitry by controlling the opening and closing of the switches in the circuitry, as further described below by FIGS. 4-6. Various aspects of the circuitry of the neuron—such as pumping of charge, integration, multiplication, and clipping—are described below by FIGS. 7-11. To control the circuitry, the digital controller 106 can also perform, for example, the following tasks: communicate with devices external to the electrical chip 102 via a communication protocol such as the Inter-Integrated Circuit (I²C) protocol, which is a 2-wire bus protocol for communication between devices; activate (e.g., initiate) the electrical chip 102; assign and provide a weight for each input of each neuron to that neuron; and write values of the weights in the memory device 110 using the communication protocol.

The ADC 108 can receive the analog output (which can be a voltage, as shown by the electrical circuit in FIG. 3) of each neuron, and can convert the analog output into a digital format compatible with the digital controller 106. The digital controller 106 can save the output. The digital output stored by the digital controller 106 can be converted back into an analog output, which can then be provided as an input to the same neuron that is now being used as a neuron of the next layer. Because the same neuron can be used to perform computations (e.g., pumping of charge, integration, multiplication, and clipping) for multiple layers, the neuron is effectively reused, thereby advantageously minimizing the use of analog components used to create the neural network 104.

The memory device 110, which is external to the neural network 104, can store a corresponding weight for each input of every neuron in the neural network 104. Storage of weights in a memory device rather than electrical components of a circuit can advantageously minimize the use of analog components used to create the neural network 104. In the neural network 104, the output of each neuron (e.g., a particular neuron) can be connected with an input of each neuron (i.e., every neuron, including that particular neuron), as described by FIG. 2. As each neuron also has one analog sensor input 112 as an input, the shown example with 49 neurons has 50 inputs (which includes outputs of all 49 neurons, and 1 analog sensor input 112). If the analog neural network 104 has 50 layers of neurons (one of which has 49 neurons, as shown), the memory device 110 needs space to store 50 layers×50 weights per layer=2500 weights. If each weight needs 4 bits of memory space for storage, the memory device 110 must have, in this example, a minimum size of 2500 weights×4 bits per weight=10 kilobits=1.25 kilobytes. While, in this example, the analog neural network 104 has 49 neurons, the analog neural network 104 has 50 layers of neurons, and the each weight needs a memory space of 4 bits for storage, in other examples, the analog neural network 104 can have any other number of neurons, the analog neural network 104 can have any other number of layers, and/or each weight can have any other memory requirements for storage of such weight.

The arrows shown in the drawing between the analog neural network 104, the digital controller 106, the analog-to-digital converter 108, and the memory device 110 indicate electrical connections between those electrical components of the electrical chip 102.

FIG. 2 illustrates portion 202 of a layer of the neural network 104 showing that each neuron 204/206 receives, as input, (a) one analog sensor input and (b) outputs of each neuron 204 and 206. The analog sensor input for the neuron 204 is 208, which is a part of inputs 112 shown in FIG. 1. The analog sensor input for the neuron 206 is 210, which is also a part of inputs 112 shown in FIG. 1.

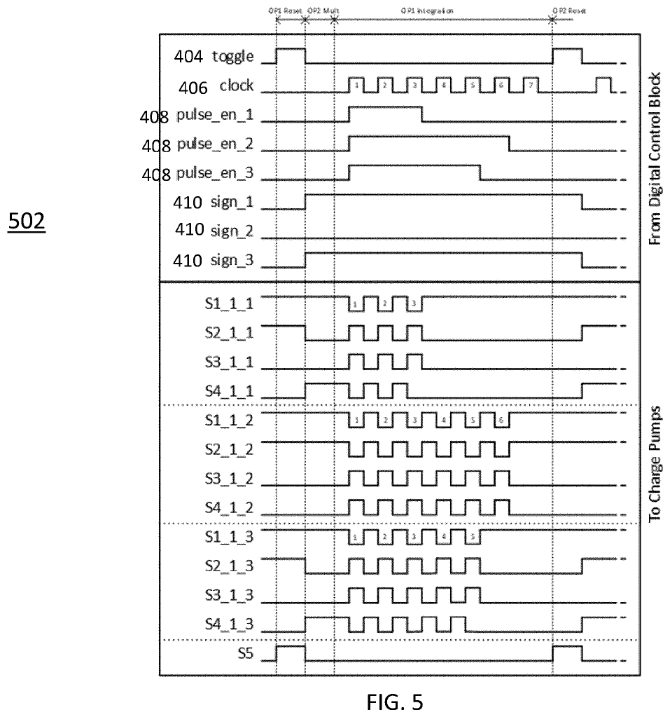

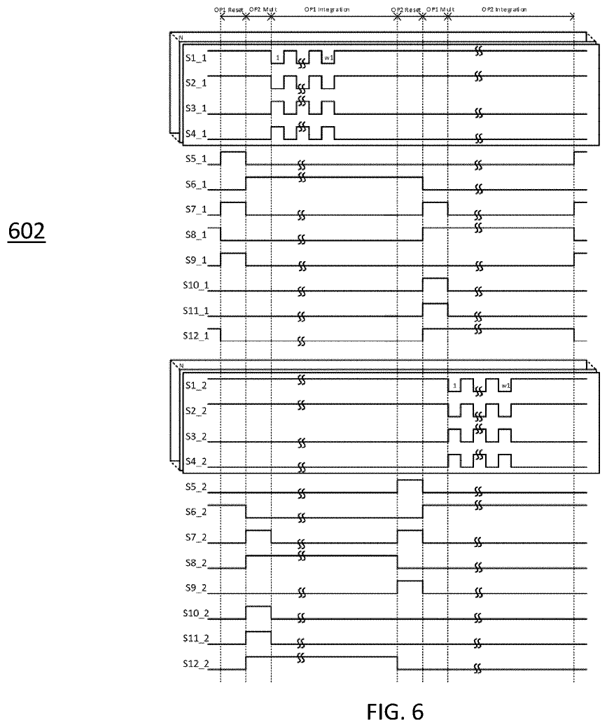

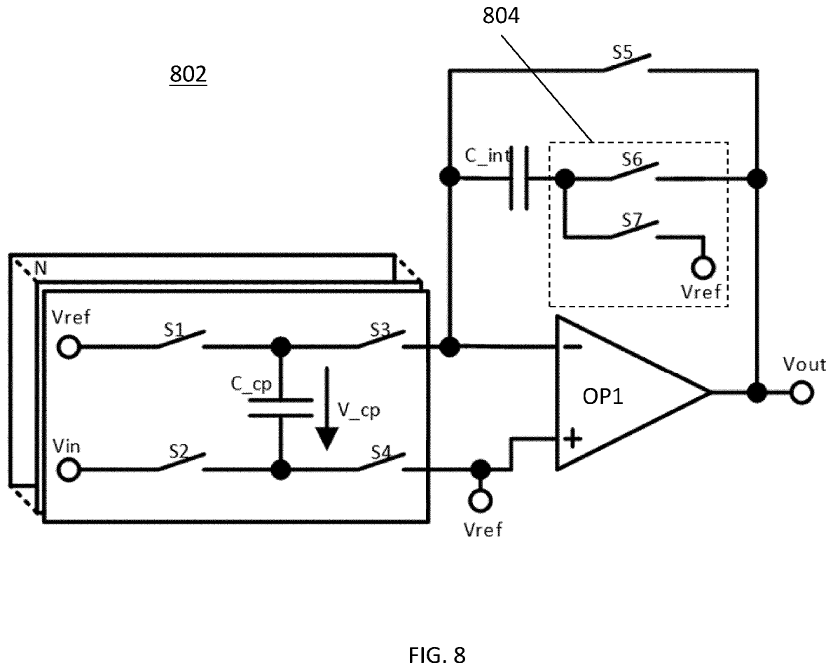

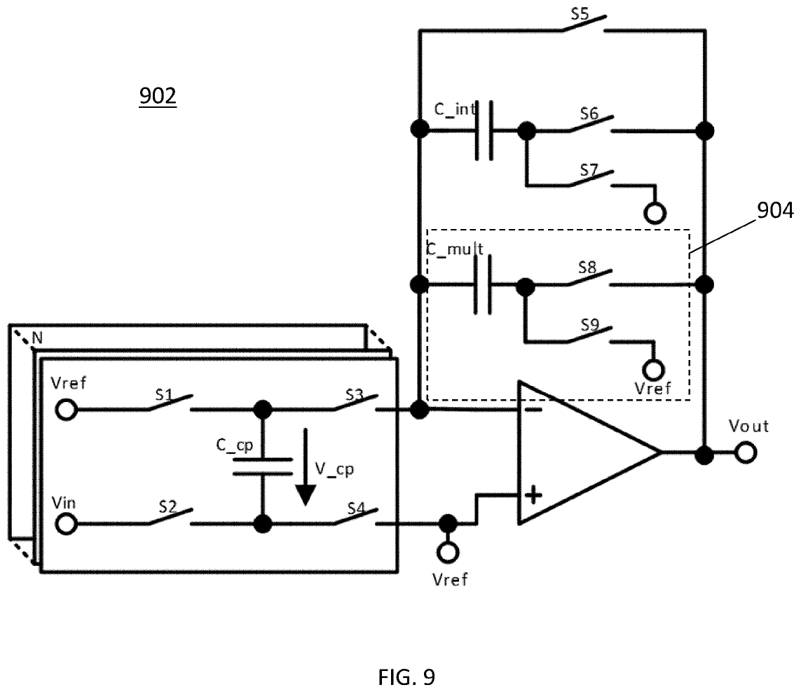

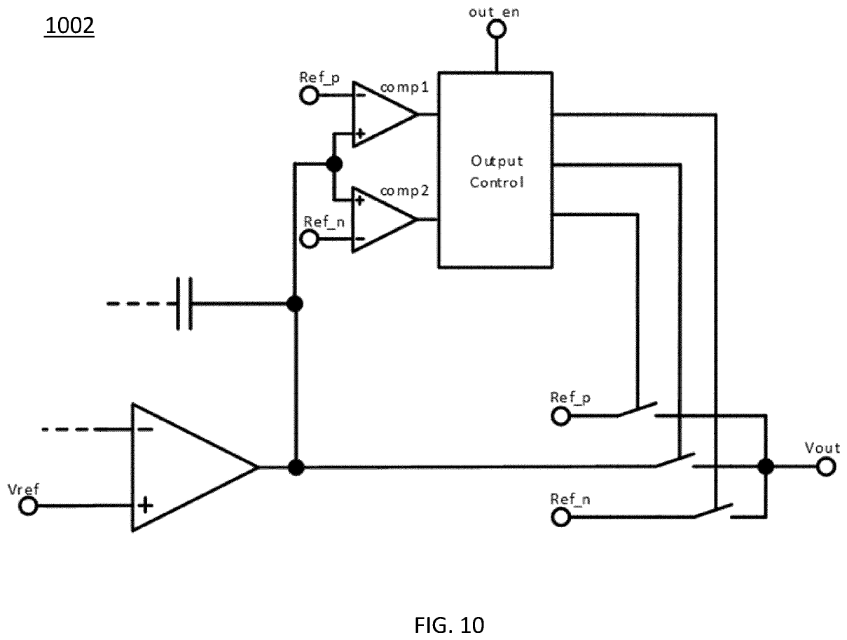

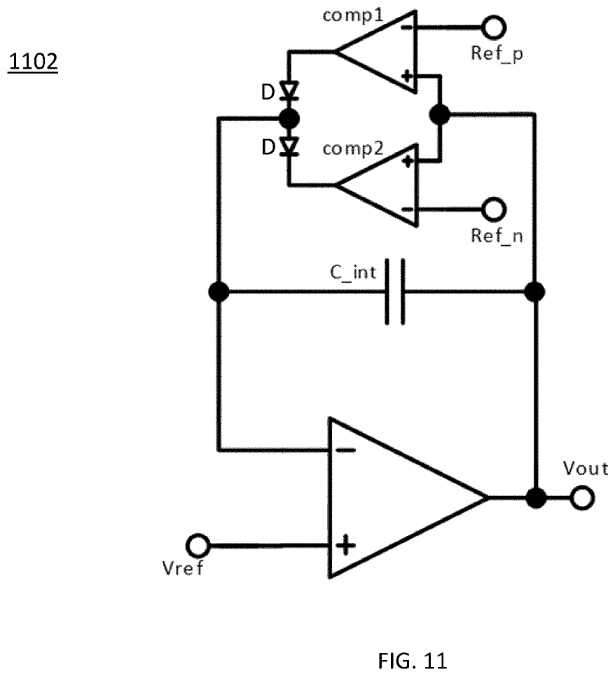

FIG. 3 illustrates an electrical circuit 302 forming a neuron 303 within the neural network 104. The neuron 303 has also been referred to using reference numerals 204 and 206 in FIG. 2. The electrical circuit 302 of the neuron 303 can include two integrators 304, two charge pumps 306, and a clipper circuit 308. The functionality of the electrical circuit 302 can be controlled by activation and deactivation of switches, all of which begin with reference symbol S in the drawing. The switches can be controlled using a controller described below by FIG. 4. The timing diagram explaining the functionality of such controller and the switches is described below by FIG. 5. Another example of the timing diagram for the neuron 303 is described below by FIG. 6. A portion of the electrical circuit 302, which includes the charge pump 306 and a portion of the integrator 304, is described below by FIG. 7 to explain the functionality of the neuron. A further portion of the electrical circuit 302, which includes the charge pump 306 and another portion of the integrator 304, is described below by FIG. 8 to explain offset compensation attained by the electrical circuit 302. Another portion of the electrical circuit 302, which includes the charge pump 306 and yet another portion of the integrator 304, is described below by FIG. 9 to describe output amplification attained by the circuit 302. The clipper circuit 308 is described below by FIG. 10 to explain clipping of the output voltage. An alternative implementation for the clipper circuit 308 is described below by FIG. 11.

To buffer the output (i.e., save the result Vout of the neuron 303 until such output is provided as input to the neuron 303 subsequently being reused for another layer of the neural network 104), the architecture of the neuron 303 is designed such that each neuron 303 includes two integrators 304 (specifically, 304a and 304b) and two charge pumps 306 (specifically 306a and 306b), as shown. When the first integrator 304a acts as an output buffer (i.e., holds constant the value of the output Vout generated by the neuron 303 when the neuron 303 is used for, for example, the first time as a neuron 303 within a first layer of the neural network 104), the second integrator 304b calculates the next output (i.e., Vout of the neuron 303 when the neuron 303 is being reused—e.g., used for the second time—as a neuron within a second (i.e., subsequent) layer of the neural network 104). Subsequently, the second integrator 304b is switched to act as a buffer to save the output it calculated, and the first integrator 304a is switched to calculating the next output.

For an integrator 304 to act as a buffer, the output of the integrator 304 is connected to the output of the neuron 303 by controlling the switches S_12_1 and S_12_2, which in turn holds the output Vout constant. More specifically, if the operational amplifier OP1 is in buffer mode, then the switch S_12_1 is closed and the switch S_12_2 is open. Therefore, the output Vout of the neuron is the output of the operational amplifier OP1, which is connected to one input of each neuron. The operational amplifier OP2 then calculates (i.e., integrates, multiplies and clips) the next output value (e.g., Vout of the neuron when the neuron is being reused for, for example, a subsequent layer of the neural network 104). Subsequently, OP2 switches to being a buffer, and the output value of the operational amplifier OP2 is connected to the output by closing the switch S_12_2 and opening the switch S_12_1. The operational amplifier OP1 calculates (integrates, multiplies and clips) at this time.

In an alternate architecture for the neuron 303, the electrical circuit 302 can include a single integrator circuit (instead of two, as shown in the drawing) and one additional buffer circuit with sample capacitor. Such alternative electrical circuit may however not be suitable in at least some situations, as additional offset errors may be introduced that may not be easily eliminated.

Because the neural network 104 is an analog neural network, the calculations needed for the propagation of the data through the network 104 are, at least, partly done as analog computations without the need of a digital processor. This can offer the following advantages over the use of a digital neural network: (a) very high parallelism as all neurons 303 can operate at the same time, (b) fast execution as calculations are simple analog operations, and (c) low power consumption due to efficient data processing.

FIG. 4 illustrates a digital controller 402 for each neuron 303 to control the switches in the electrical circuit 302 forming the neuron 303 within the neural network 104. Each neuron 303 within a layer of the neural network 104 can have a separate digital controller 402 that generates the control signals for all the switches of that neuron 303, and such digital controllers 402 can be a part of the digital controller 106. In an alternate implementation, however, all the neurons of a layer can be coupled to the same digital controller 402, which can be same as the digital controller 106. For the two neurons 204 and 206 in FIG. 2, for example, each of the two neurons has 3 analog inputs—a first input being the analog sensor input 112, a second input being an output of that neuron, and a third input being an output of the other neuron—(N=3), as well as 8 digital inputs including a toggle signal 404, a clock signal 406, a pulse_en signal 408 for each analog sensor input 112, and a sign signal 410 for each analog sensor input 112. Based on the digital inputs, the digital controller 402 can activate and/or deactivate one or more switches (which are shown on the right of the digital controller 402 in the drawing). The activation and deactivation of switches by the digital controller 402 in response to the inputs is clarified below by the timing diagram of FIG. 5.

FIG. 5 illustrates a timing diagram 502 illustrating a functionality of the digital controller 402 controlling the switches in the electrical circuit 302 forming the neuron 303.

The toggle input 404 can cause a toggling of the functionality of the operational amplifier OP1 and the operational amplifier OP2—i.e., first, the operational amplifier OP1 is set to integration mode and the operational amplifier OP2 is used to buffer the output of the previous calculation; and with the next toggle pulse, the operational amplifier OP2 gets into the integration mode and the operational amplifier OP1 gets into buffer mode; and such toggling goes on with subsequent toggling phases. During the high period of the toggle signal 404, the operational amplifier that is to be used as the integrator next is in reset mode—i.e., the output of such operational amplifier is set to 0 Volts.

The number of clock pulses on the clock line 406 can define the maximum possible applied weight. In the shown example, accordingly, the maximum possible weight is 7. The pulse-width of the pulse_en signals 408 is defined by the weight. For example, if the digital controller 402 indicates that input1 of neuron1 has a weight of 3, then the pulse_en_1 signal will be high for 3 clock cycles, which causes charge to be pumped 3 times into the integration capacitor C_int.

The digital controller 402 can set the sign signals 410 with the falling edge of the toggle signal 404. If the sign pulse 410 is 1, the value is negative; and if the sign pulse 410 is 0, the value is positive. The sign bit 410 can control (e.g., by determining) whether the charge pump capacitor C_cp will be pre-charged with the input voltage (with switches S1 and S2 being closed, and the switches S3 and S4 being open) or with 0 Volts (with the switches S1 and S4 being closed, and the switches S2 and S3 being open).

In the shown example, the weight for the first analog input is −3 (which is represented by 3 pulses and sign=1), the weight for the second analog input is +6 (which is represented by 6 pulses and sign=0), and the weight for the third analog input is −5 (which is represented by 5 pulses and sign=1).

After the multiplication phase, when the outputs of the previous layer are settled (i.e., the outputs of the previous layer become stable), the integration phase begins. This means as long as the pulse_en signal 408 is high, the charge pump 306 pulses the charge into the integration capacitor 304. For example, at input 1, the sign is 1, which means that the capacitor C_cp is being pre-charged with 0 Volts (with the switches S1 and S4 being closed, and the switches S2 and S3 open). During the high period of the clock signal 406, the switches S1 and S4 are opened and the switches S2 and S3 are closed, which causes a charge transfer into the integration capacitor C_int, which leads to a decreasing integrator output voltage Vout. In the next low phase, the charge pump capacitor C_cp again gets charged with 0 Volts. This is repeated as long as the pulse_en1 signal 408 is high. The pulse_en signals 408 are generated by the digital controller 106.

FIG. 6 illustrates another timing diagram 602 for calculating two layers for one neuron represented by the electrical circuit 302. Calculation of a layer, as noted here, refers to integration of all input signals, multiplication of the integrated signals with their weight, and clipping of the result if the result exceeds a positive or negative reference voltage. In the first layer, the operational amplifier OP1 can be in an integration mode and the operational amplifier OP2 can be in a buffer mode.

During the reset phase, the integration capacitor C_int1 and the multiplication capacitor C_mult1 of the operational amplifier OP1 are charged with the offset voltage. This can be attained by closing the switches S5_1, S7_1 and S9_1.

After the reset phase, the operational amplifier OP2 can be switched into the multiplication mode, by disconnecting the integration capacitor C_int2 from the output and connect it to the reference voltage while connecting C_mult2 to the output. This is done by opening the switch S6_2, and closing the switches S7_2, S8_2 and S12_2. At the same time, the clipping circuit 308 is activated, which is done by closing the switches S10_2 and S11_2, in order to clip the output if it would exceed the positive or negative clipping reference.

When the multiplication phase is finished, the integration phase for the operational amplifier OP1 and the buffer phase for the operational amplifier OP2 begins. Depending on the sign of the weight for each of the N inputs, the switches S1_1, S2_1, S3_1, and S4_1 can be manipulated to push the input dependent charge into the integration capacitor C_int1 or pull it out from that integration capacitor C_int1. The weight can indicate the number of pulses that are applied on each input.

After finishing the integration phase, the operational amplifier OP2 gets into the reset mode, which means the integration capacitor C_int2 of the operational amplifier OP2 is discharged, so it can take the integration functionality for the next layer. Then the multiplication phase for the operational amplifier OP1 begins. By opening the switches S6_1 and closing the switches S7_1 and S8_1, the charge stored in the integration capacitor C_int1 can be transferred into the multiplication capacitor C_mult1. This multiplies the output by the factor C_int_1/C_mult_1. Again, during the multiplication phase, the clipping circuit 308 is activated by closing the switches S10_1 and S11_1. Then the operational amplifier OP1 goes into buffer mode and the operational amplifier OP2 starts integrating.

When finished integrating, again the operational amplifier OP1 changes into reset mode and so on.

FIG. 7 illustrates a circuit portion 702, within the electrical circuit 302 of the neuron, that includes a charge pump 306 and an integrator (formed using an operational amplifier) 704. The integrator 704 is a part of the integrator 304a shown in FIG. 3. Further portions of the integrator 304a (which are not a part of the circuit 704) are added to the integrator 704 in FIGS. 8 and 9 (discussed below) to describe other functionalities of the integrator 304a.

The integrator 704 integrates (e.g., sums-up) the charge transferred by the charge pump 306. The charge pump 306 is a direct current (DC) to DC converter that uses the capacitor C_cp for energetic charge storage to raise or lower voltage. The integrator 704 can be a current integrator, which is an electronic device performing a time integration of an electric current, thus measuring a total electric charge. In some implementations, any of the integrators described herein (e.g., integrator 704 or 304) can also be referred to as a multiplier or an adder.

In the charge pump circuit 306, Vref refers to reference voltage, Vin refers to input voltage, C_cp refers to charge pump capacitor, V_cp refers to voltage differential across the charge pump capacitor C_cp, and S1, S2, S3 and S4 refer to switches. In the integrator circuit 704, OP1 refers to the operational amplifier that is being used as an integrator by combining it with other electrical components of the integrator circuit 704, Vout refers to the output voltage, C_int refers to integration capacitor, Vref refers to the reference voltage, and S5 refers to a switch.

The integration capacitor C_int is configured to store the charge accumulated using the charge pump 306. The integration capacitor C_int can be discharged (e.g., reset) by closing the switch S5. Depending on the sign 410 of the weight, charge can be added or subtracted to the integration capacitor C_int—i.e., by charging or discharging the integration capacitor—during the time when integration is being performed (i.e., the integration period). To add charge to the integration capacitor C_int, switches S1 and S4 are closed and switches S2 and S3 are opened, thereby causing the charge pump capacitor C_cp to initially be discharged.

Subsequently, switches S1 and S4 are opened and switches S2 and S3 are closed, causing one side of the capacitor C_cp to be connected to the negative input of the operational amplifier OP1 and the other side of the charge pump capacitor C_cp to the neuron input Vin. Further, the negative input of the operational amplifier 204 increases, which leads to a change of the integrator output voltage Vout, and to a corresponding change in the current from the neuron input Vin through the charge pump capacitor C_cp and the integration capacitor C_int. Then the voltage across the charge pump capacitor C_cp has the value of V_cp=−Vin and a charge of Q_cp=−Vin*C_cp. This means a charge of Q=Vin*Cp has been transferred and added into the integration capacitor C_int.

For subtracting charge from the integration capacitor C_int, the process works the other way around. First, switches S1 and S2 are closed and switches S3 and S4 are opened, thereby pre-charging the charge pump capacitor C_cp with Q_cp=−Vin*C_cp. Subsequently, switches S1 and S2 are opened and switches S3 and S4 are closed, causing the charge pump capacitor C_cp to be connected between the negative input of the operational amplifier OP1 and the positive input Vref of the operational amplifier OP1, which leads to discharging the charge pump capacitor C_cp and transferring a charge of Q=−Vin*C_cp into the integration capacitor C_int.

Because the neuron has many inputs, the capacitance of the integration capacitor C_int must be much larger than the charge pump capacitor C_cp in order to avoid an overflow of charge in the integration capacitor C_int. This means the output voltage Vout changes only for Vin*C_cp/C_int per charge pump pulse of one input. The weights for the individual inputs are applied using pulses of the charge pump 306 such that weight is equal to the number of charge pump pulses. See discussion with respect to FIG. 9 below for examples of quantified value of C_int relative to quantified value of C_cp.

FIG. 8 illustrates an electrical circuit 802 that has electrical component additions 804 to the circuit portion 702 of FIG. 7 to perform offset compensation. The switch S5 is closed to reset the integration capacitor C_int, as noted above with respect to FIG. 7. During such reset, the output Vout of the operational amplifier OP1 settles to the offset voltage. When switch S6 is opened and switch S7 is closed, one side of the integration capacitor C_int is connected to the reference voltage Vref, and the other side is connected via the closed switch S5 to the output Vout of the operational amplifier OP1. Therefore, the offset voltage is stored in the integration capacitor C_int. Subsequently, the reset switch S5 opens, the switch S6 is closed, and the switch S7 opens, all of which results in one side of the integration capacitor C_int being connected to the output Vout of the operational amplifier OP1. At this time, the offset voltage stored across C_int forces the output Vout to be this stored offset voltage lower than the negative input of the operational amplifier OP1, thereby compensating the offset voltage at the output.

Each neuron can have “N” inputs Vin, as shown, where each input Vin can add or subtract charge to and from the integration capacitor C_int corresponding to that input. In order to save area and reduce the number of necessary control signals, the N inputs Vin can be multiplexed. So only a small amount of inputs Vin, and therefore charge pumps 306, can be applied in parallel. The “N” inputs Vin can be stepped by using one or more multiplexers.

FIG. 9 illustrates an electrical circuit 902 that has electrical component additions 904 to the circuit portion 802 of FIG. 8 to perform output amplification.

All inputs Vin can be applied partially in parallel rather than completely in parallel, and the input signals are multiplexed. If, for example, the number of charge pumps 306 is 8 (i.e., N=8), the number of neurons is 47, each neuron has 48 inputs including one analog sensor input 112 and 47 neuron outputs (i.e., one output from each of the 47 neurons). These 48 inputs can be multiplexed to 6 times 8 parallel signals. The inputs are thus sequentially delivered to the 8 charge pumps 306 in groups of 6. Therefore, during the integration period, the integration calculations take 6 times as long as if all inputs would have been processed parallel (because first inputs 1-8 are processed, then inputs 9-16 are processed, and so on).

Because of this serial (i.e., sequential implementation), the ratio between the integration capacitance C_int and the charge pump capacitance C_cp must be made very high to avoid the integrator running into rails (which results in improper clipping of outputs). The problem of the integrator running into rails (i.e., improper clipping of the output) is now described with an example. If, for example, the inputs 1-8 have high positive input values with a high positive weight applied such that the sum of inputs*weights is 2.5V, but the supply is only 1.8V, the output shall clip at 1.8V. If, after the next group of inputs 9-16 the integrator output (i.e., sum of inputs*weights) needs to be 0.3V lower, then instead of the accurate value of 2.2V (which is 0.3V lower than the unclipped output from the previous group of 2.5V) the output computed is 1.5V (which is 0.3V less than the clipped output from the previous group of 1.8V), which is clearly inaccurate. To avoid such problem, the ratio of C_int/C_cp can, for example, be 48/1 so as to give enough headroom to get accurate results. Further note that this ration can vary with the number of input groups, and number of inputs in each input group. In another example where all 48 inputs form a single group such that all the inputs are in parallel and there is no multiplexing, then the ratio of C_int/C_cp can be 5/1 or 10/1.

Where the input is divided into 6 groups of 8 inputs, the C_int/C_cp ratio of 48/1 indicates that one pulse of one input is divided by the factor 48. With the maximum weight of 7, for example, this input with a voltage Vin leads to a maximum output of 7/48*Vin. Because the damping of the input is high, the output Vout needs to be amplified. The additional electrical component additions 904 enable such amplification, as per the following.

When all inputs Vin have been processed, the switch S6 opens and the switch S7 closes, which connects the integration capacitor C_int to the reference voltage.

The switch S8 closes and the switch S9 remains open. Then, all the accumulated charge in the integration capacitor C_int is transferred to the C_mult capacitor, which leads to an increase in the output voltage Vout by a factor of C_int/C_mult. The ratio of C_int/C_mult can be 48/7, which means the maximum input of 7/48*Vin gets multiplied by 48/7, which results in 7/48*Vin*48/7=1*Vin at maximum weight. Note that because the C mult capacitor is much smaller than C_int, the increase in voltage Vout—and thus the amplification—can be substantial.

FIG. 10 illustrates a circuit portion 1002—within the electrical circuit 302 of the neuron—that performs clipping of the output voltage Vout. The circuit portion 1002 includes a variation of the clipper circuit 308. The clipper (or clipper circuit) 1002 is an electrical circuit designed to prevent the output voltage from exceeding a range defined by a positive reference voltage Ref_p and a negative reference voltage Ref_n. Here, the comparators comp1 and comp2 compare the output voltage Vout of the integrator 304 with a positive reference voltage Ref_p and a negative reference voltage Ref_n. A comparator is a device that compares two voltages or currents, and outputs a digital signal indicating the larger voltage (or alternately, in other implementations, the larger current). The positive reference voltage Ref_p and the negative reference voltage Ref_n represent the boundaries for the clipping function. After the integration or multiplication phase, when the output of the integrator 304 is settled (i.e., when the output is stable), a digital pulse on the out en pin chooses, based on result of the comparisons by the comparators comp1 and comp2, specific output switch to be closed. If the output of the integrator 304 is higher than Ref_p, the output of comp1 will be high, and accordingly the switch to Ref_p will be closed. If the output of the integrator 304 is smaller than Ref_n, then the output of the comparator comp2 is high, and accordingly the switch to Ref_n will be closed. If the integrator output is between reference voltages Ref_p and Ref_n, outputs of both the comparator comp1 and comp2 are 0, and accordingly the switch to the output of the integrator 304 is closed.

FIG. 11 illustrates a circuit portion 1102—which is an alternative to the circuit portion 1002 of FIG. 10—that performs clipping of the output voltage. The clipping circuit 1102 clips the output voltage at a specified positive and negative voltage. Such clipping can generate the activation function for the neuron. This is also used to hold the output signal, which is used as input signal for the next loop, low in order to further increase the headroom of the neuron. The clipping circuit 1102 includes two comparators comp1 and comp2, positive pins of which are connected to the output voltage Vout, and the negative pins of which are connected to a positive reference voltage Ref_p and a negative reference voltage Ref_n. The outputs of the comparators comp1 and comp 2 are connected via a diode D to the negative input of the amplifier. If the neuron output is higher than the positive reference voltage, then the output of comp1 goes high and charges the capacitor C_mult through the diode until the output voltage Vout equals the positive reference voltage Ref_p. For negative clipping, it works the same or similar way with the comparator comp2.

Various implementations of the subject matter described herein can be implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can be have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

Although various implementations have been described in detail above, other modifications can be possible. For example, the logic flows depicted in the accompanying figures and described herein do not require the particular order shown, or sequential order, to achieve desirable results. Other implementations are within the scope of the following claims.

1. An apparatus comprising:
an analog neural network comprising a first layer having a plurality of neurons, the plurality of neurons configured to be reused to form a second layer of the analog neural network, each neuron having a plurality of inputs;
a digital controller coupled to the analog neural network to provide a weight for each input of the plurality of inputs; and
a memory device coupled to the digital controller to store the weight for each input of the plurality of inputs.

2. The apparatus of claim 1, further comprising an analog-to-digital converter coupled to the analog neural network to receive an analog output of the analog neural network, the analog-to-digital converter configured to convert the analog output of the analog neural network to a digital output compatible with the digital controller, the analog-to-digital converter coupled to the digital controller to transmit the digital output to the digital controller.

3. The apparatus of claim 1, wherein the plurality of outputs for each neuron of the plurality of neurons comprises:
an analog input of a plurality of analog inputs from a sensor coupled to the analog neural network; and
an output of each neuron of the plurality of neurons.

4. The apparatus of claim 3, wherein:
the plurality of analog inputs are input to the first layer of neural network; and
a count of the analog inputs equals a count of the neurons.

5. The apparatus of claim 4, wherein the plurality of analog inputs are multiplexed to form sets of parallel signals, each set of the sets of parallel signals being sequentially processed by the analog neural network.

6. The apparatus of claims 1, wherein each neuron comprises a first charge pump, a first operational amplifier, a second charge pump, and a second operational amplifier.

7. The apparatus of claim 6, wherein:
the first charge pump is coupled to the first operational amplifier;
the second charge pump is coupled to the second operational amplifier; and
the first operational amplifier is operable as a buffer to persist an output of the neuron when associated with the first layer while the second operational amplifier is operable as an integrator to compute an output of the neuron when being reused as part of the second layer.

8. The apparatus of claim 7, wherein the second operational amplifier is operable to switch for operation as another buffer to persist the output of the neuron when being reused as part of the second layer while the first operational amplifier is operable to switch for operation as another integrator to compute an output of the neuron when being further reused as part of a third layer of the neural network.

9. The apparatus of claim 6, wherein each of the first operational amplifier and the second operational amplifier is coupled with electrical components configured to perform offset compensation.

10. The apparatus of claim 6, wherein each of the first operational amplifier and the second operational amplifier is coupled with electrical components configured to amplify an output of the analog neural network.

11. The apparatus of claim 6, wherein each neuron further comprises a clipper circuit configured to clip an output of one of the first operational amplifier and the second operational amplifier to keep the output within a predetermined range of voltage values.

12. The apparatus of claim 1, wherein each neuron of the plurality of neurons has an electrical circuit including a plurality of switches, wherein opening and closing of each switch of the plurality of switches is controlled by the digital controller.

13. An apparatus for an electrical circuit of an analog neuron of a neural network, the apparatus comprising:
a first operational amplifier configured to act as a buffer to persist an output of the neuron when the neuron is associated with a first layer of the neural network; and
a second operational amplifier configured to act as an integrator to compute an output of the neuron when the neuron is being reused as part of a second layer of the neural network.

14. The apparatus of claim 13, further comprising:
a first charge pump coupled to the first operational amplifier, the first charge pump configured to vary a voltage at an input of the first operational amplifier; and
a second charge pump coupled to the second operational amplifier, the second charge pump configured to vary a voltage at an input of the second operational amplifier.

15. The apparatus of claim 13, further comprising a clipper circuit configured to clip an output of one of the first operational amplifier and the second operational amplifier to keep the output within a predetermined range of voltage values.

16. The apparatus of claim 13, wherein:
the second operational amplifier is configured to switch to act as another buffer to persist the output of the neuron when being reused as part of the second layer; and
the first operational amplifier is configured to switch to act as another integrator to compute an output of the neuron when being further reused as part of a third layer of the neural network.

17. The apparatus of claim 13, wherein each of the first operational amplifier and the second operational amplifier is coupled with electrical components configured to perform offset compensation.

18. The apparatus of claim 13, wherein each of the first operational amplifier and the second operational amplifier is coupled with electrical components configured to amplify an output of the analog neural network.
